(19) United States
(12) Patent Application Publication
(10) Pub. No.: US 2026/0044538 A1
(43) Pub. Date: Feb. 12, 2026

(54) DYNAMIC USER PERSONALIZATION USING LARGE LANGUAGE MODELS

(71) Applicant: Cisco Technology, Inc., San Jose, CA (US)

(72) Inventors: Christopher Robert Liu, Foster City, CA (US); Karthik Raghunathan, Sunnyvale, CA (US)

(21) Appl. No.: 18/795,353

(22) Filed: Aug. 6, 2024

(51) Int. Cl. G06F 16/332; G06F 16/338; G06F 40/30

(52) U.S. Cl. CPC G06F 16/3329; G06F 16/338; G06F 40/30

(57) ABSTRACT

A method, computer system, and computer program product are provided for dynamic user personalization using large language models. A conversation history is obtained comprising a plurality of messages associated with a user’s activity in a messaging system. The conversation history and a request to identify interests of the user, based on the conversation history, are provided to a large language model. A natural language output is received from the large language model comprising one or more identified interests of the user. A text sample, the natural language output, and a request to summarize the text sample based on the natural language output are provided to the large language model. A summary of the text sample that is personalized based on the one or more identified interests of the user is received from the large language model.

### TECHNICAL FIELD

The present disclosure relates generally to artificial intelligence and machine learning.

### BACKGROUND

As compared to generic artificial intelligence (AI) or machine learning (ML) models, user-personalized models typically provide better performance because a personalized model can factor in a user's specific preferences and behaviors better than a generic model, thus delivering more accurate and relevant output. Conventional approaches to user personalization are achieved by deploying large and expensive trained per-user models that demand ongoing computational resources to address any shifts or changes in user preferences. Constantly adapting to real-time shifts in user preferences and tastes can be costly and/or impractical, as doing so requires model retraining, which incurs significant computational expenses and time delays.

### BRIEF DESCRIPTION OF THE DRAWINGS

FIG. 1 is a block diagram depicting a network environment for providing personalized large language model (LLM) services, according to an example embodiment.

FIG. 2 is a block diagram depicting a personalized LLM processing flow, according to an example embodiment.

FIG. 3 is a block diagram depicting a process for autogenerating personalized text using an LLM, according to an example embodiment.

FIG. 4 is a flow chart depicting a method for generating personalized text summaries using an LLM, according to an example embodiment.

FIG. 5 is a block diagram of a device that may be configured to perform operations relating to LLM personalization, as presented herein.

### DETAILED DESCRIPTION

### Overview

According to one embodiment, techniques are provided for dynamic user personalization using large language models. A conversation history is obtained comprising a plurality of messages associated with activity of a user in a messaging system. The conversation history and a request to identify interests of the user, based on the conversation history, are provided to a large language model. A natural language output is received from the large language model comprising one or more identified interests of the user. A text sample, the natural language output, and a request to summarize the text sample based on the natural language output are provided to the large language model. A summary of the text sample that is personalized based on the one or more identified interests of the user is received from the large language model.

### Example Embodiments

Present embodiments relate to artificial intelligence and machine learning, and more specifically, to using large language models for user personalization techniques. A large language model (LLM) is an artificial intelligence (AI) system designed to understand, generate, and manipulate human language. These models are based on deep learning techniques, and in particular, a type of neural network architecture known as a transformer. Using this architecture, LLMs can process and generate text in a coherent and contextually appropriate manner. LLMs are typically trained on vast amounts of data from a variety of sources. LLMs can have millions to billions of parameters, which are the weights that are adjusted during training. As such, training an LLM can be a time-consuming process that is computationally expensive.

Whereas a general-purpose LLM generates output that is user-agnostic, a personalized LLM could provide output that highlights details of interest to a user. Conventional approaches to personalizing LLMs for particular users involve an LLM to be trained based on the user’s interests. An LLM could be personalized for a user by selectively providing training data that represents the user’s interest. For example, the training data can be overrepresented with regard to text examples that are in a user’s primary language, or examples that relate to the user’s interests. However, this conventional approach involves training a different model for each user, which is unfeasible.

Therefore, a mechanism for on-the-fly model adaptation and user personalization that does not incur a significant compute or time cost is highly desirable. To address this problem, the embodiments presented herein provide an improved approach to personalizing LLM models using techniques that automatically identify topics of interest for a given user, such as interests or responsibilities (e.g., responsibilities with respect to a task, project, occupation, etc.). In particular, an LLM can scan relevant sections of a user’s conversation history to identify interests and/or responsibilities of the user. A few-shot prompt can also be provided to the LLM, which is a prompt that includes one or more examples of the output that a user desires the LLM to generate. Thus, the user’s interests and/or responsibilities can be generated in a human-readable format, whereas other machine learning approaches would not be human-readable. The user’s interests and/or responsibilities can then be provided to the LLM along with a request to perform a generative task, which is personalized based on the user’s interests and/or responsibilities.

Thus, the embodiments presented herein enable an LLM to generate personalized output without requiring training to do so. In some embodiments, the LLM can summarize messages or other documents for a user in a manner that focuses on certain topics depending on the user’s roles and/or responsibilities. In other embodiments, the user’s interests and/or responsibilities are provided to an LLM to influence the output in applications such as text generation about a subject. For example, an LLM can generate a response to an e-mail that addresses user responsibilities, even in the case that the input e-mail does not explicitly or implicitly mention those responsibilities.

Additionally, when a user interacts with a conventional AI model, the user has limited or no visibility on the kind of user profile that the model has built for the user, such as the specific factors that the model uses to personalize their experience. When user personalization is achieved through model fine-tuning or custom per-user model training (as is the case in conventional approaches), the personalization is built into the weights of the model in a manner that is not human-interpretable. According to conventional techniques, users may receive personalized recommendations under vague headings such as “Inspired by your browsing history” or “Selected for you”. In contrast, the user’s interests and/or responsibilities that are generated according to the embodiments presented herein are human-readable, providing insights for the user. Moreover, since the user’s interests and/or responsibilities are human-readable, the user’s profile can be edited to include additional interests and/or responsibilities, to modify interests and/or responsibilities, or to remove interests and/or responsibilities.

Thus, present embodiments improve the technical field of machine learning and AI by achieving LLM personalization without requiring training of an LLM to specialize in the interests of a specific person. The embodiments presented herein drastically reduce the processing and time requirements that are necessitated by conventional techniques. Moreover, present embodiments provide insights regarding how the model profiles users since the user interests and/or responsibilities are both human-readable and usable by the model. Thus, present embodiments provide the practical application of improving user-personalized processing by LLMs.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

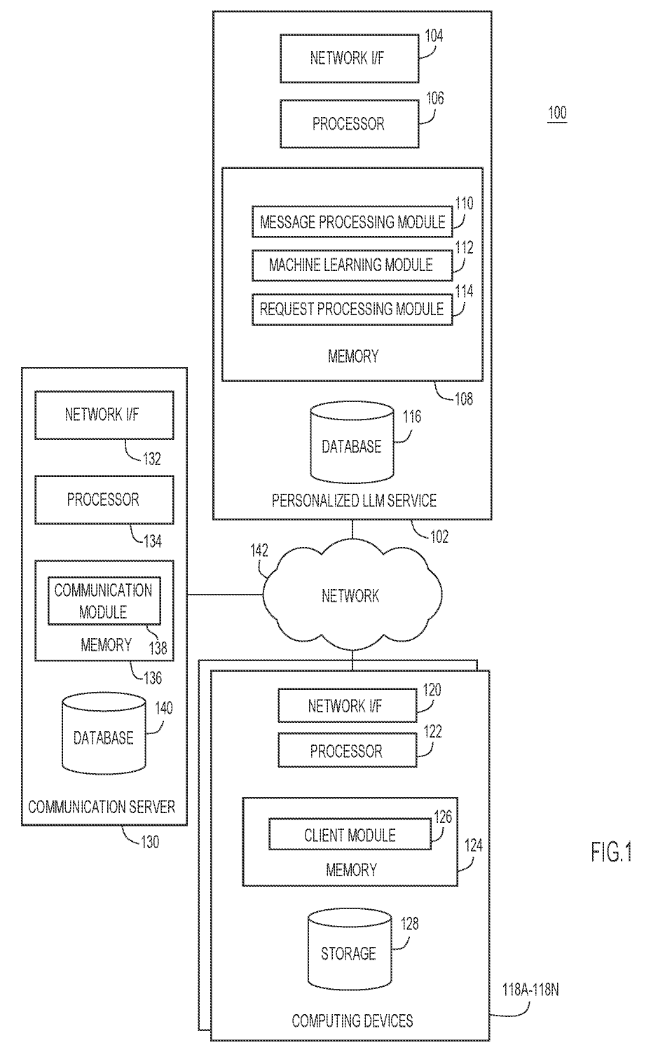

With reference now to FIG. 1, a block diagram is presented depicting a network environment 100 for providing personalized LLM services, according to an example embodiment. As depicted, network environment 100 includes a personalized LLM service 102, a plurality of computing devices 118A – 118N, and a communication server 130 that are in communication via a network 142. It is to be understood that the functional division among components have been chosen for purposes of explaining various embodiments and is not to be construed as a limiting example.

Personalized LLM service 102 includes a network interface (I/F) 104, at least one processor (computer processor) 106, memory 108 (which stores instructions for a message processing module 110, a machine learning module 112, and a request processing module 114), and a database 116. In various embodiments, personalized LLM service 102 may include one or more rack-mounted servers, laptops, desktops, or any other programmable electronic device capable of executing computer readable program instructions. Network interface 104 may be a network interface card that enables components of personalized LLM service 102 to send and receive data over a network, such as network 142. Personalized LLM service 102 may be configured to analyze user communications to identify interests and/or responsibilities of a user, which are used to provide personalized LLM services. Since personalized LLM service 102 includes an LLM (e.g., as implemented via machine learning module 112), personalized LLM service 102 and/or the components thereof may each include a number of servers in various locations.

Message processing module 110, machine learning module 112, and request processing module 114 may include one or more modules or units to perform various functions of the embodiments described below. Message processing module 110, machine learning module 112, and request processing module 114 may be implemented by any combination of any quantity of software and/or hardware modules or units, and may reside within memory 108 of personalized LLM service 102 for execution by a processor, such as processor 106.

Message processing module 110 may be configured to handle the acquisition, processing, and contextual analysis of user messages within a messaging platform. This module operates within an environment that supports various forms of electronic communication, including but not limited to, email, chat programs, and/or transcripts of audio conversations. Initially, message processing module 110 obtains user messages, which may include any messages sent or received by a particular user. Message processing module 110 may integrate with one or more messaging platforms (e.g., communication server 130) through one or more interfaces to capture message data in real-time or near real-time. The messaging platforms can include any communication or collaboration platform.

In particular, message processing module 110 can establish a connection with a messaging platform via one or more Application Programming Interface (APIs) in order to retrieve the message data. The message data may include any communications between users of computing devices 118A – 118N, and can be obtained by accessing a local storage (e.g., storage 128) of a computing device and/or by accessing a database that stores exchanged messages (e.g., database 140 of communication server 130). Message data may include sender and recipient identities, timestamps, message content, and/or metadata such as labels, tags, and read/unread statuses. To provide a context of each message, message processing module 110 can aggregate additional messages exchanged with the user within a specified time window (e.g., a time span before and/or after a particular message), including messages sent to, or received from, other users within a particular time frame surrounding a given message. In some embodiments, the messages that are obtained may include messages sent by a user, messages to which the user reacted, and/or messages in which the user is mentioned either explicitly or implicitly. Thus, for example, if a user responded to a message with an affirmative reaction (e.g., a thumbs-up) or the word “yes”, then the message may be obtained to provide a context for the user’s response. Retrieved message data can be stored in database 116 for subsequent processing.

Message processing module 110 may perform ranking of messages based on a semantic similarity analysis. In some embodiments, message processing module 110 employs an embedding model to determine semantic similarity between text samples (e.g., words or sentences extracted from the message data obtained with respect to a particular user). The message data that is collected regarding a user can be separated into smaller segments (e.g., sentences) and converted to vectors for the embedding model using techniques such as word2vec or BERT. Using the embedding model, messages or individual sentences thereof can be ranked by relevance. In some embodiments, the messages are ranked based on similarity to a target embedding representation using a measure such as cosine similarity. The target embedding representation may be obtained by vectorizing an input query or statement such as “What are [user’s name] responsibilities and interests?” (where “[user’s name]” would be replaced with the name of the user, e.g., “John Doe”) or a similar question or statement regarding the responsibilities and/or interests of the particular user.

Thus, the messages can be ranked based on the degree of similarity to a statement or question regarding the user’s responsibilities and interests. However, since user responsibilities and/or interests can shift over time, in some embodiments a time decay function may be applied. The time decay function may downrank the similarity measure of messages based on how old the messages are, which can be determined using the timestamp metadata associated with each message. By applying time decay to the semantic ranking, older discussions may be deprioritized.

By filtering and ranking messages, a number of top-ranked messages can be used for processing by an LLM. Machine learning module 112 may include one or more LLMs, which can be implemented locally or accessed via an API or other protocol. In some embodiments, machine learning module 112 may include an LLM that is implemented using a distributed computing infrastructure that includes multiple Graphics Processing Units (GPUs), Tensor Processing Units (TPUs), central processing units (CPUs), high-speed interconnects, non-volatile memories, high-bandwidth memories, and the like. The LLM(s) of machine learning module 112 may be trained using a large corpus of training data in which multiple different subject matter areas are represented. As a generative model, the LLM(s) can be trained to receive as input human-readable text and likewise, generate human-readable text as output.

Machine learning module 112 may receive the output of message processing module 110, which can include a number of messages regarding a particular user, which can be filtered and/or ranked by message processing module 110. A prompt can be provided to the LLM which includes the selected messages and a request to determine the user’s interests and/or responsibilities based on the messages. In some embodiments, a few-shot prompt may additionally be provided as input. Few-shot prompting is a technique in which examples (called “shots”) are provided to a model to demonstrate the type of output that is desired by the model. For example, a few-shot prompt can include a heading of a user’s responsibilities followed by a list of example responsibilities and a heading of a user’s interests followed by a list of example interests. In some embodiments, a one-shot prompt is included, which is a single example of the type of output that is desired. However, a zero-shot approach may be utilized in which no example is provided to the LLM.

When the LLM receives the selected messages, a request to determine a user’s responsibilities and/or interests, and optionally, a few-shot prompt (which may comprise a one-shot prompt), the LLM processes the messages in order to identify responsibilities and/or interests of the user. The output of the LLM may include human-readable text, which can include a listing of words or sentences describing the responsibilities and/or interests of the user. This output can be stored in a database (e.g., database 116) for use when a user requests personalized LLM services.

Request processing module 114 may process requests from users for personalized LLM services. A request can include a prompt for an LLM, and optionally, other data, such as one or more documents, media, hyperlinks to web-accessible content, and the like. Each request may be provided by a user (e.g., a user of any of computing devices 118A – 118N). In various example embodiments, the requests can include a request for an LLM to perform a summarization task (e.g., “summarize this document”, etc.), a request to generate text (e.g., “generate a poem in the style The Raven by Poe”), a request to translate text from one language to another, or any other task that an LLM can perform. In some embodiments, the request may automatically be generated and transmitted by a computing device; for example, a computing device may place a request for an LLM to summarize unread messages received by a user.

Additionally, each request may indicate the user who is associated with the request. The identity of the user can be determined based on which user is logged into a computing device (e.g., any of computing devices 118A – 118N) that submits a request. When request processing module 114 receives a request, request processing module 114 may determine the identity of the user responsible for the request, and request processing module 114 can obtain the user profile data that includes that user’s interests and/or responsibilities. The request may be provided to machine learning module 112 along with the user’s interests and/or responsibilities for processing via an LLM.

The prompt for an LLM that is included in a received request may be modified by inserting an instruction to generate the output based on the user’s interests and/or responsibilities, which are also included in the prompt. Thus, machine learning module 112 may provide an LLM with a prompt, a request to generate a response based on the user’s interests and/or responsibilities, and a listing of the user’s interests and/or responsibilities. The output of the LLM may be provided to request processing module 114, which can transmit the output as a response to the device that placed the request (e.g., any of computing devices 118A – 118N).

Database 116 may include any non-volatile storage media known in the art. For example, database 116 can be implemented with a tape library, optical library, one or more independent hard disk drives, or multiple hard disk drives in a redundant array of independent disks (RAID). Similarly, data in database 116 may conform to any suitable storage architecture known in the art, such as a file, a relational database, an object-oriented database, and/or one or more tables. Database 116 may store data that includes user message data and/or user profile data (e.g., user interests and/or responsibilities). In some embodiments, database 116 may store data corresponding to one or more trained LLMs, including the weights and biases of a trained model.

Computing devices 118A – 118N may each include a network interface (I/F) 120, at least one processor (computer processor) 122, memory 124 (which stores instructions for a client module 126), and storage 128. In various embodiments, computing devices 118A – 118N may each include a rack-mounted server, laptop, desktop, smartphone, tablet, or any other programmable electronic device capable of executing computer readable program instructions. Network interface 120 enables components of each computing devices 118A – 118N to send and receive data over a network, such as network 142. Each computing device 118A – 118N may be used by users to exchange messages (e.g., chat messages, emails, etc.) and/or to access personalized LLM service 102 in accordance with the embodiments presented herein. Storage 128 may include a non-volatile storage medium in which messages sent and/or received by a user can be stored locally.

Client module 126 may include one or more modules or units to perform various functions of the embodiments described below. Client module 126 may be implemented by any combination of any quantity of software and/or hardware modules or units, and may reside within memory 124 of any of computing devices 118A – 118N for execution by a processor, such as processor 122. In some embodiments, client module 126 may perform various operations to enable a user of each computing device 118A – 118N to communicate with other users. For example, client module 126 may include a client for initiating and/or participating in group chat sessions (e.g., sessions hosted by communication server 130). However, in various other environments, client module 126 may be an email client, Short Messaging Service (SMS) client, or other type of client that is configured for exchanging messages between two or more users. As such, client module 126 may utilize any known or other communication protocols to exchange data between computing devices 118A – 118N during communication sessions, including text messages (e.g., chat messages), as well as audio data, video data, documents, and/or other data. The exchange of message data among users of computing devices 118A – 118N is thus facilitated by client module 126 in combination with communication module 138 of communication server 130, which may serve as a host.

In some embodiments, client module 126 enables a user to access an LLM service (e.g., machine learning module 112 of personalized LLM service 102) to submit prompts for processing. Client module 126 may receive a prompt as user input, which can be transmitted to personalized LLM service 102 as a request for processing. The prompt may also include documents, links to documents, or other media for LLM processing tasks such as summarization. The results of LLM processing may be received by client module 126 for presentation to the user. In some embodiments, client module 126 enables a user to view the user’s profile data, which can include human-readable interests and/or responsibilities of the user. The user can request that the user’s profile be updated to identify old, new, and/or modified responsibilities and/or interests based on current messages. In some embodiments, the user may edit the user profile data to adjust or correct any identified interests and/or responsibilities, thereby improving the accuracy of personalized LLM services using user feedback.

Communication server 130 includes a network interface (I/F) 132, at least one processor (computer processor) 134, memory 136 (which stores instructions for communication module 138), and a database 140. In various embodiments, communication server 130 may include one or more rack-mounted servers, laptops, desktops, or any other programmable electronic device capable of executing computer readable program instructions. Network interface 132 may be a network interface card that enables components of communication server 130 to send and receive data over a network, such as network 142. Communication server 130 may be configured to act as a host for the exchange of communications between users of computing devices 118A – 118N. In particular, communication module 138 may perform host functions (e.g., receiving data from client module 126 of each computing device 118A – 118N and transmitting the data to other users).

Communication module 138 may include one or more modules or units to perform various functions of the embodiments described below. Communication module 138 may be implemented by any combination of any quantity of software and/or hardware modules or units, and may reside within memory 136 of communication server 130 for execution by a processor, such as processor 134. Communication module 138 may facilitate communication between users so that the users can share data, including text data, video data, audio data, and/or data corresponding to content items, with the other participants. The communications may include any form of messaging between users, including chat messages, e-mails, or other messages.

Database 140 may include any non-volatile storage media known in the art. For example, database 140 can be implemented with a tape library, optical library, one or more independent hard disk drives, or multiple hard disk drives in a redundant array of independent disks (RAID). Similarly, data in database 140 may conform to any suitable storage architecture known in the art, such as a file, a relational database, an object-oriented database, and/or one or more tables. Database 140 may store user message data, which can include a history of any messages sent or received by users of computing devices 118A – 118N via any communication protocol or service, including user message data, email data, and the like. In some embodiments, communication module 138 may host audio communication sessions between two or more users; the audio data may be converted to text and stored in database 140 for analysis in accordance with the embodiments presented herein.

Network 142 may include a local area network (LAN), a wide area network (WAN) such as the Internet, or a combination of the two, and includes wired, wireless, or fiber optic connections. In general, network 142 can be any combination of connections and protocols known in the art that will support communications between personalized LLM service 102, computing devices 118A – 118N, and/or communication server 130 via their respective network interfaces in accordance with the described embodiments.

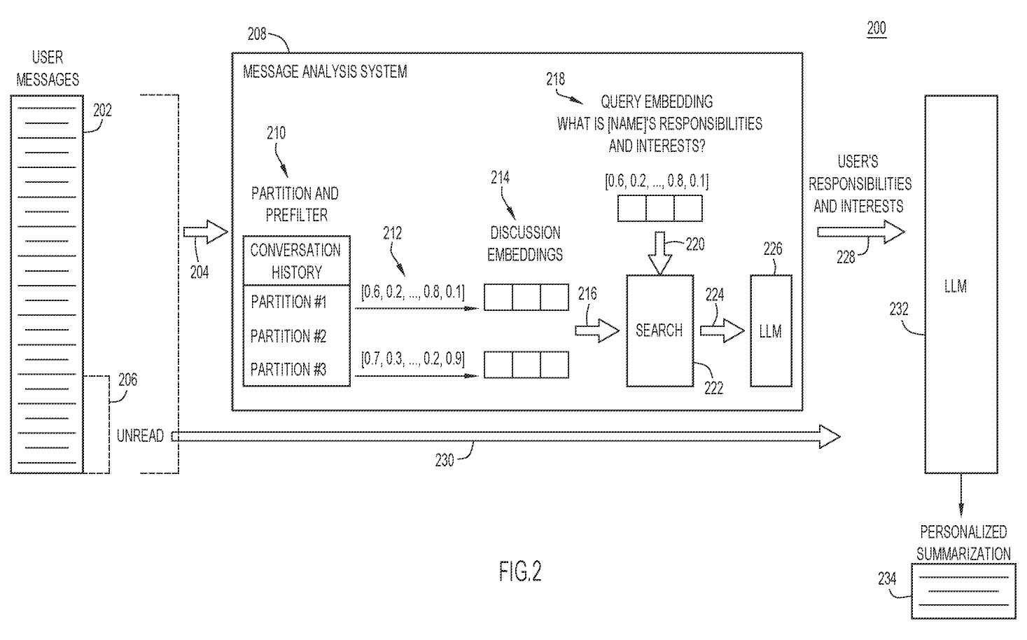

With reference now to FIG. 2, a block diagram is provided depicting a personalized LLM processing flow 200, according to an example embodiment.

Initially, user messages 202 are obtained for processing using a message analysis system 208 (which can be implemented using personalized LLM service 102 and its components, as depicted and described with reference to FIG. 1). The user messages 202 may include a conversation history with respect to a user, which can include all messages sent or received by a user. In the depicted example, a subset of user messages 202 includes unread messages 206, e.g., messages that a user has received but has not yet read. Additionally, user messages 202 can include a context window surrounding some or all of the messages, including messages received from other users within a threshold window of time of a particular message that was sent or received by the user.

The user messages 202 may be provided to message analysis system 208 at operation 204 so that the user’s interests and/or responsibilities can be determined. The user messages 202 may be partitioned and prefiltered at operation 210. Partitioning the messages may involve separating larger messages into smaller sections (e.g., using a MapReduce approach). The prefiltering operations may select a subset of messages based on predefined conditions. In some embodiments, the user messages 202 are filtered so that only the following messages are processed further by message analysis system 208: messages sent by a user, messages to which a user reacted, and/or messages in which a user is mentioned or otherwise referenced. The prefiltering operations thus enable message analysis system 208 to process a subset of messages that are most likely to be relevant for determining a user’s interests and/or responsibilities.

After the partitioning and prefiltering (operation 210), each partition (e.g., each sentence that remains after filtering) can be converted into a vector 212 for analysis using an embedding model that is configured to determine the semantic similarity between sentences. Then, the vectors 212 are used as discussion embeddings at operation 214, and these discussion embeddings are provided to the embedding space at operation 216. The embedding model can be queried to rank messages by relevance. A query embedding 218 can be obtained by vectorizing a query, such as “what is [name]’s responsibilities and interests”. The query may be a question, a sentence, or a listing of words or phrases that are selected to identify a user’s interests and/or responsibilities. As another example, the query that is used to obtain query embedding 218 may be a word or phrase including, but not limited to, any of the following: “duties,” “obligations”, “tasks”, “roles”, “functions”, “jobs”, “assignments”, “commitments”, “accountability”, “liabilities”, “hobbies”, “pursuits”, “activities”, “preferences”, etc.

The query embedding 218 can be provided to the embedding space at operation 220 and used to search the embedding space at operation 222. The query embedding 218 can be used to search the embedding space by finding semantically similar sentences (e.g., by identifying the closest vectors using a measure such as cosine similarity). Thus, sentences can be ranked according to their semantic similarity to a user’s responsibilities and/or interests. In some embodiments, the semantic similarity value is modified using a time-decay function that is based on the age of each message; thus, older messages that would otherwise have higher semantic similarity values are instead assigned reduced semantic similarity values, as older messages may be less relevant to a user’s current responsibilities and/or interests.

Once the messages are ranked, a number of messages with a highest semantic similarity to the query embedding 218 may be provided to an LLM 226 at operation 224. In some embodiments, the number of messages is a predefined number, such as a top N messages; similarly, a top Nth percentile of messages may be selected. In other embodiments, the number of messages that are selected may be determined according to the context window of the LLM: the maximum number of highest-ranked messages may be provided that the context window will support.

The LLM 226 may then determine the user’s responsibilities and/or interests based on the messages that are provided to the LLM at operation 224. The LLM 226 can generate the user’s responsibilities and/or interests in a human-readable form that generalizes the user’s responsibilities and/or interests. For example, rather than indicating that a user is interested in a specific programming language, the output may indicate that the user is interested in a group of similar programming languages or programming languages in general (e.g., low-level programming languages, high-level programming languages, etc.).

The user’s responsibilities and/or interests are provided to an LLM 232 at operation 228, and text to summarize (in this case, the user’s unread messages 206) is provided to the LLM 232 at operation 230. The LLM 232 may be the same LLM as LLM 226, or a different LLM can be used. Using a prompt that includes the user’s responsibilities and/or interests and text to summarize, LLM 232 can output a personalized summarization 234 of the text based on the user’s responsibilities and/or interests. The personalized summarization 234 may include a greater amount of detail with regard to topics that correspond to the user’s responsibilities and/or interests and/or a lesser amount of detail with regard to other topics. For example, if a user has unread messages about a particular project that falls under the user’s responsibilities, and unread messages about a social function, then a majority of the personalized summarization 234 may relate to the unread messages about the project, with fewer details about the social function.

In various other embodiments, personalized summarization 234 can include a summarization of documents uploaded by a user, a summarization of documents attached to unread messages of a user, a summarization of audio and/or video media provided to the LLM, a summarization of a web-accessible document or other resource, and the like. In some embodiments, personalized summarization 234 is generated by first providing a prompt to LLM 232 to summarize one or more documents, and then providing a prompt the LLM 232 to minimize or omit any aspects of the summary that do not match the user’s interests and/or responsibilities.

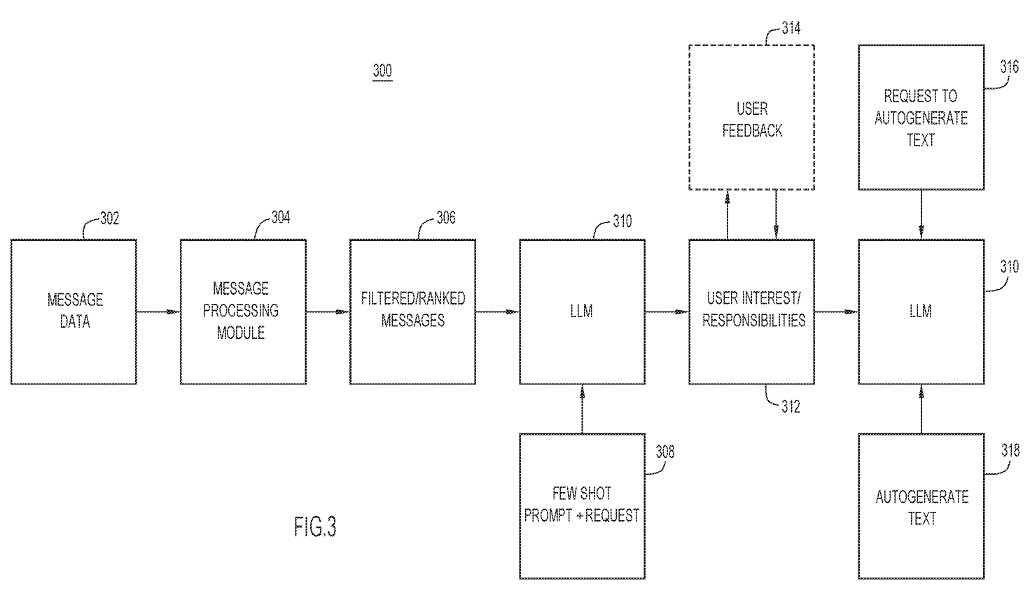

FIG. 3 is a block diagram depicting a process 300 for autogenerating personalized text using an LLM, according to an example embodiment. As depicted, process 300 includes a message processing module 304 that initially processes message data 302, and an LLM 310 that is used to identify user interests and/or responsibilities and to autogenerate text.

Initially, message data 302 may be provided to a message processing module 304. The message data 302 may include a history of messages that have been sent or received by a user via one or more communications services (e.g., a group chat application, e-mail, etc.). Message data 302 may be obtained from local storage of a user’s endpoint device, from a communication server’s database, or a combination thereof. The message data 302 is provided to message processing module 304, which performs one or more filtering operations in order to select and rank relevant messages for further processing in process 300. In particular, message processing module 304 may select a subset of messages from message data 302 that includes messages sent by the user, messages to which the user reacted or responded, and messages in which the user was discussed (e.g., explicitly by name or implicitly by title, antecedent reference, etc.). These remaining messages can then be ranked according to relevance by message processing module 304. In particular, an embedding model may be utilized to convert each message to an embedding and compare the distance between each embedding to a query embedding that includes a question or reference to the user’s interests and/or responsibilities. The most similar messages can be identified in the embedding model using a semantic similarity measure to the query embedding by computing a similarity value that enables messages to be ranked by relevance. In some embodiments, a time decay function is applied to the similarity values to adjust the values such that more recent messages are increased in relevance and/or older messages are decreased in relevance.

Message processing module 304 may output the filtered/ranked messages 306 to an LLM 310 along with a few-shot prompt (optionally) and request 308 for generating output. The few-shot prompt can include an example of the type of output that is desired from LLM 310, and the request for generating output (e.g., interests and/or responsibilities of the user) can indicate that the output should be based on the filtered/ranked messages 306. LLM 310 can process the few-shot prompt and request 308 in combination with the filtered/ranked messages 306 in order to identify user interests and/or responsibilities 312. As output from LLM 310, the user interests and/or responsibilities 312 may be human-readable and can be described in a particular manner or format that may be based on the examples of the few-shot prompt. Optionally, a user may review the user interests and/or responsibilities 312 to provide user feedback 314, which can include one or more additions, modifications, and/or deletions to the user interests and/or responsibilities 312. The user feedback 314 may be provided by a user who is the subject of the user interests and/or responsibilities 312 or another user, such as a supervisor, administrator, etc. In some embodiments, the user interests and/or responsibilities 312 may be automatically modified based on a role of the user to include additional interests and/or responsibilities. For example, even if message data 302 does not indicate that the user is responsible for a particular project, the user interests and/or responsibilities 312 can be modified to include that project.

The user interests and/or responsibilities 312 may then be provided to LLM 310 (or a different LLM) along with a request to autogenerate text 316. Alternatively, a cached version of user interests and/or responsibilities may be used, rather than generating user interests and/or responsibilities 312 each time text is autogenerated. The request to autogenerate text 316 can include a request to describe a project or technology, a request to answer a question, a request to respond to an email or other message, and the like. The autogenerated text 318 may then be generated based on the user interests and/or responsibilities 312 in a manner that satisfies the request to autogenerate text 316 while focusing on the user interests and/or responsibilities 312. For example, the autogenerated text 318 may include details that relate to the user interests and/or responsibilities 312 while omitting or minimizing other details. In some embodiments, the autogenerated text 318 may be transmitted as a response to a message, optionally pending user approval. In some embodiments, LLM 310 may additionally generate autogenerated text 318 based on interests and/or responsibilities of a recipient of the autogenerated text 318. For example, when both a user and recipient have same or similar interests and/or responsibilities, the autogenerated text 318 may include details that relate to the common interests and/or responsibilities, minimizing or omitting other details.

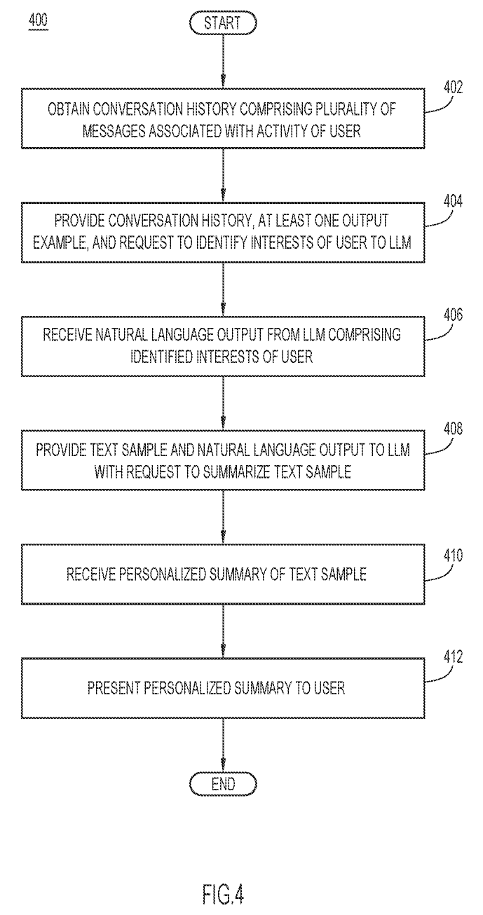

FIG. 4 is a flow chart depicting a method 400 for generating personalized text summaries using an LLM, according to an example embodiment.

A conversation history is obtained that comprises a plurality of messages associated with activity of a user at operation 402. The messages may be obtained from a history of message activity between a user and one or more other users, and can include messages sent by the user, messages received by the user, and/or any reactions to messages (e.g., a “thumbs up” acknowledgement, etc.). Each message may include a timestamp. The conversation history can be processed to filter the messages to include only the message sent by the user, messages that mention the user, and/or messages to which the user reacted. Additionally, a context can be obtained for each message that includes other messages from other users within a time window of each particular message. In some embodiments, the messages that are filtered may then be ranked according to semantic similarity to a query regarding the user’s interests and/or responsibilities, and a number of top-ranked messages may then be selected, omitting the rest of the messages. In some embodiments, the semantic similarity is further adjusted using a time decay function that effectively lowers the semantic similarity of older messages as compared to newer messages.

The conversation history, at least one output example, and a request to identify the interests of the user are provided to an LLM at operation 404. The output example can include a one-shot prompt that serves as an example to the LLM for the type of output that is desired. In some embodiments, the one-shot prompt may be an example listing of responsibilities and an example listing of interests of one or more users. The conversation history that is provided to the LLM may be a subset of messages that are filtered and ranked according to operation 402.

A natural language output is received from the LLM that comprises one or more identified interests of the user at operation 406. The natural language output may also include responsibilities of the user. As one example, a natural language output may be: “User's responsibilities: providing guidance on feature prioritization, determining engineering bandwidth allocation, and approving expense reports. User's interests: machine learning model development, language AI roadmap progress, and employee career development.”

A text sample and the natural language output is provided to the LLM with a request to summarize the text sample at operation 408. The text sample may include text to be summarized in a personalized manner by the LLM. In some embodiments, the text sample may include any messages received by the user that the user has not yet read, or that the user has marked as unread. In another embodiment, the text sample may include a meeting transcript for a meeting that the user did not attend.

A personalized summary of the text sample is received from the LLM at operation 410. The LLM may summarize the text sample based on the content of the text sample as well as the interests and/or responsibilities of the user. The personalized summary may thus maximize details that relate to the user’s interests and/or responsibilities while minimizing details that do not.

The personalized summary is provided to the user at operation 412. The personalized summary can be presented via a user interface so that the user can briefly gain insights into the text sample. In some embodiments, the user may interact with the personalized summary by selecting a portion of interest, and in response, any full portions of the original text sample that relate to the summarized portion of interest may be presented to the user. Thus, the user can gain a full understanding of the content in the text sample.

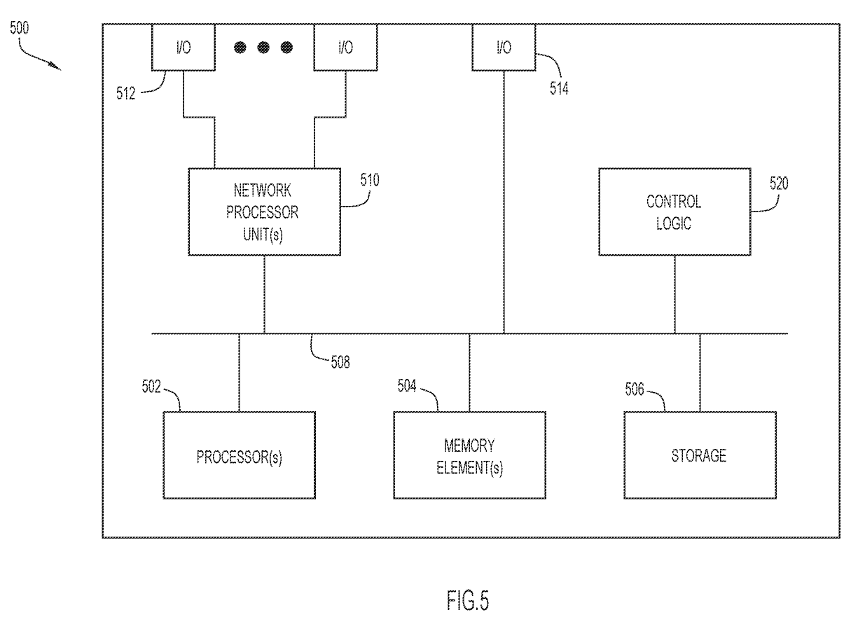

Referring now to FIG. 5, FIG. 5 illustrates a hardware block diagram of a computing device 500 that may perform functions associated with operations discussed herein in connection with the techniques depicted in FIGS. 1 – 4. In at least one embodiment, the computing device 500 may include one or more processor(s) 502, one or more memory element(s) 504, storage 506, a bus 508, one or more network processor unit(s) 510 interconnected with one or more network input/output (I/O) interface(s) 512, one or more I/O 514, and control logic 520. In various embodiments, instructions associated with logic for computing device 500 can overlap in any manner and are not limited to the specific allocation of instructions and/or operations described herein.

In at least one embodiment, processor(s) 502 is/are at least one hardware processor configured to execute various tasks, operations and/or functions for computing device 500 as described herein according to software and/or instructions configured for computing device 500. Processor(s) 502 (e.g., a hardware processor) can execute any type of instructions associated with data to achieve the operations detailed herein. In one example, processor(s) 502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 504 and/or storage 506 is/are configured to store data, information, software, and/or instructions associated with computing device 500, and/or logic configured for memory element(s) 504 and/or storage 506. For example, any logic described herein (e.g., control logic 520) can, in various embodiments, be stored for computing device 500 using any combination of memory element(s) 504 and/or storage 506. Note that in some embodiments, storage 506 can be consolidated with memory element(s) 504 (or vice versa), or can overlap/exist in any other suitable manner.

In at least one embodiment, bus 508 can be configured as an interface that enables one or more elements of computing device 500 to communicate in order to exchange information and/or data. Bus 508 can be implemented with any architecture designed for passing control, data and/or information between processors, memory elements/storage, peripheral devices, and/or any other hardware and/or software components that may be configured for computing device 500. In at least one embodiment, bus 508 may be implemented as a fast kernel-hosted interconnect, potentially using shared memory between processes (e.g., logic), which can enable efficient communication paths between the processes.

In various embodiments, network processor unit(s) 510 may enable communication between computing device 500 and other systems, entities, etc., via network I/O interface(s) 512 (wired and/or wireless) to facilitate operations discussed for various embodiments described herein. In various embodiments, network processor unit(s) 510 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between computing device 500 and other systems, entities, etc. to facilitate operations for various embodiments described herein. In various embodiments, network I/O interface(s) 512 can be configured as one or more Ethernet port(s), Fibre Channel ports, any other I/O port(s), and/or antenna(s)/antenna array(s) now known or hereafter developed. Thus, the network processor unit(s) 510 and/or network I/O interface(s) 512 may include suitable interfaces for receiving, transmitting, and/or otherwise communicating data and/or information in a network environment.

I/O 514 allow for input and output of data and/or information with other entities that may be connected to computing device 500. For example, I/O 514 may provide a connection to external devices such as a keyboard, keypad, mouse, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 520 can include instructions that, when executed, cause processor(s) 502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 504 and/or storage 506 can store data, software, code, instructions (e.g., processor instructions), logic, parameters, combinations thereof, and/or the like used for operations described herein. This includes memory element(s) 504 and/or storage 506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 602.11 (e.g., Wi-Fi®/Wi-Fi6®), IEEE 602.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

In some aspects, the techniques described herein relate to a computer-implemented method including: obtaining a conversation history including a plurality of messages associated with activity of a user in a messaging system; providing the conversation history and a request to identify interests of the user, based on the conversation history, to a large language model, wherein the at least one output example includes desired output of the large language model; receiving a natural language output from the large language model including one or more identified interests of the user; providing to the large language model, a text sample, the natural language output, and a request to summarize the text sample based on the natural language output; and receiving from the large language model a summary of the text sample that is personalized based on the one or more identified interests of the user.

In some aspects, the techniques described herein relate to a computer-implemented method, wherein the text sample includes unread messages associate with the user.

In some aspects, the techniques described herein relate to a computer-implemented method, wherein the plurality of messages includes one or more of: messages sent by the user, messages to which the user responded, and messages in which the user is mentioned.

In some aspects, the techniques described herein relate to a computer-implemented method, wherein the plurality of messages further includes one or more messages sent or received within a predetermined time span of one or more of: the messages sent by the user, the messages to which the user responded, and the messages in which the user is mentioned.

In some aspects, the techniques described herein relate to a computer-implemented method, further including: modifying the natural language output based on input from the user prior to providing the natural language output to the large language model.

In some aspects, the techniques described herein relate to a computer-implemented method, further including filtering the plurality of messages using an embedding model to select one or more messages having a semantic similarity within a threshold similarity to a query for interests of the user.

In some aspects, the techniques described herein relate to a computer-implemented method, further including adjusting the semantic similarity of the plurality of messages based on a time at which each message of the plurality of messages is sent or received.

In some aspects, the techniques described herein relate to a computer-implemented method, further including: providing to the large language model the natural language output and a request to generate autogenerated text based on a prompt; and transmitting the autogenerated text to a computing device.

In some aspects, the techniques described herein relate to a computer-implemented method, further including: presenting the summary of the text sample to the user via a user interface.

In some aspects, the techniques described herein relate to a computer-implemented method, wherein providing the conversation history and the request to identify interests of the user, based on the conversation history, to the large language model further includes providing at least one output example to the large language model.

In some aspects, the techniques described herein relate to a system including: one or more computer processors; one or more computer readable storage media; and program instructions stored on the one or more computer readable storage media for execution by at least one of the one or more computer processors, the program instructions including instructions to: obtain a conversation history including a plurality of messages associated with activity of a user in a messaging system; provide the conversation history and a request to identify interests of the user, based on the conversation history, to a large language model, wherein the at least one output example includes desired output of the large language model; receive a natural language output from the large language model including one or more identified interests of the user; provide to the large language model, a text sample, the natural language output, and a request to summarize the text sample based on the natural language output; and receive from the large language model a summary of the text sample that is personalized based on the one or more identified interests of the user.

In some aspects, the techniques described herein relate to a system, wherein the text sample includes unread messages associate with the user.

In some aspects, the techniques described herein relate to a system, wherein the plurality of messages includes one or more of: messages sent by the user, messages to which the user responded, and messages in which the user is mentioned.

In some aspects, the techniques described herein relate to a system, wherein the plurality of messages further includes one or more messages sent or received within a predetermined time span of one or more of: the messages sent by the user, the messages to which the user responded, and the messages in which the user is mentioned.

In some aspects, the techniques described herein relate to a system, wherein the program instructions further include instructions to: modify the natural language output based on input from the user prior to providing the natural language output to the large language model.

In some aspects, the techniques described herein relate to a system, further including filtering the plurality of messages using an embedding model to select one or more messages having a semantic similarity within a threshold similarity to a query for interests of the user.

In some aspects, the techniques described herein relate to one or more non-transitory computer readable storage media having program instructions embodied therewith, the program instructions executable by a computer to cause the computer to perform operations including: obtaining a conversation history including a plurality of messages associated with activity of a user in a messaging system; providing the conversation history and a request to identify interests of the user, based on the conversation history, to a large language model, wherein the at least one output example includes desired output of the large language model; receiving a natural language output from the large language model including one or more identified interests of the user; providing to the large language model, a text sample, the natural language output, and a request to summarize the text sample based on the natural language output; and receiving from the large language model a summary of the text sample that is personalized based on the one or more identified interests of the user.

In some aspects, the techniques described herein relate to one or more non-transitory computer readable storage media, wherein the text sample includes unread messages associate with the user.

In some aspects, the techniques described herein relate to one or more non-transitory computer readable storage media, wherein the plurality of messages includes one or more of: messages sent by the user, messages to which the user responded, and messages in which the user is mentioned.

In some aspects, the techniques described herein relate to one or more non-transitory computer readable storage media, wherein the plurality of messages further includes one or more messages sent or received within a predetermined time span of one or more of: the messages sent by the user, the messages to which the user responded, and the messages in which the user is mentioned.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A computer-implemented method comprising:
obtaining a conversation history comprising a plurality of messages associated with activity of a user in a messaging system;
providing the conversation history and a request to identify interests of the user, based on the conversation history, to a large language model;
receiving a natural language output from the large language model comprising one or more identified interests of the user;
providing to the large language model, a text sample, the natural language output, and a request to summarize the text sample based on the natural language output; and
receiving from the large language model a summary of the text sample that is personalized based on the one or more identified interests of the user.

2. The computer-implemented method of claim 1, wherein the text sample includes unread messages associate with the user.

3. The computer-implemented method of claim 1, wherein the plurality of messages includes one or more of: messages sent by the user, messages to which the user responded, and messages in which the user is mentioned.

4. The computer-implemented method of claim 3, wherein the plurality of messages further includes one or more messages sent or received within a predetermined time span of one or more of: the messages sent by the user, the messages to which the user responded, and the messages in which the user is mentioned.

5. The computer-implemented method of claim 1, further comprising:
modifying the natural language output based on input from the user prior to providing the natural language output to the large language model.

6. The computer-implemented method of claim 1, further comprising filtering the plurality of messages using an embedding model to select one or more messages having a semantic similarity within a threshold similarity to a query for interests of the user.

7. The computer-implemented method of claim 6, further comprising adjusting the semantic similarity of the plurality of messages based on a time at which each message of the plurality of messages is sent or received.

8. The computer-implemented method of claim 1, further comprising:
providing to the large language model the natural language output and a request to generate autogenerated text based on a prompt; and
transmitting the autogenerated text to a computing device.

9. The computer-implemented method of claim 1, further comprising:
presenting the summary of the text sample to the user via a user interface.

10. The computer-implemented method of claim 1, wherein providing the conversation history and the request to identify interests of the user, based on the conversation history, to the large language model further includes providing at least one output example to the large language model, wherein the at least one output example comprises desired output of the large language model.

11. A system comprising:
one or more computer processors;
one or more computer readable storage media; and
program instructions stored on the one or more computer readable storage media for execution by at least one of the one or more computer processors, the program instructions comprising instructions to:
obtain a conversation history comprising a plurality of messages associated with activity of a user in a messaging system;
provide the conversation history and a request to identify interests of the user, based on the conversation history, to a large language model;
receive a natural language output from the large language model comprising one or more identified interests of the user;
provide to the large language model, a text sample, the natural language output, and a request to summarize the text sample based on the natural language output; and
receive from the large language model a summary of the text sample that is personalized based on the one or more identified interests of the user.

12. The system of claim 11, wherein the text sample includes unread messages associate with the user.

13. The system of claim 11, wherein the plurality of messages includes one or more of: messages sent by the user, messages to which the user responded, and messages in which the user is mentioned.

14. The system of claim 13, wherein the plurality of messages further includes one or more messages sent or received within a predetermined time span of one or more of: the messages sent by the user, the messages to which the user responded, and the messages in which the user is mentioned.

15. The system of claim 11, wherein the program instructions further comprise instructions to:
modify the natural language output based on input from the user prior to providing the natural language output to the large language model.

16. The system of claim 11, further comprising filtering the plurality of messages using an embedding model to select one or more messages having a semantic similarity within a threshold similarity to a query for interests of the user.

17. One or more non-transitory computer readable storage media having program instructions embodied therewith, the program instructions executable by a computer to cause the computer to perform operations including:
obtaining a conversation history comprising a plurality of messages associated with activity of a user in a messaging system;
providing the conversation history and a request to identify interests of the user, based on the conversation history, to a large language model;
receiving a natural language output from the large language model comprising one or more identified interests of the user;
providing to the large language model, a text sample, the natural language output, and a request to summarize the text sample based on the natural language output; and
receiving from the large language model a summary of the text sample that is personalized based on the one or more identified interests of the user.

18. The one or more non-transitory computer readable storage media of claim 17, wherein the text sample includes unread messages associate with the user.

19. The one or more non-transitory computer readable storage media of claim 17, wherein the plurality of messages includes one or more of: messages sent by the user, messages to which the user responded, and messages in which the user is mentioned.

20. The one or more non-transitory computer readable storage media of claim 19, wherein the plurality of messages further includes one or more messages sent or received within a predetermined time span of one or more of: the messages sent by the user, the messages to which the user responded, and the messages in which the user is mentioned.
